(19) United States
(12) Patent Application Publication
(10) Pub. No.: US 2016/0348630 A1
(43) Pub. Date: Dec. 1, 2016

(54) FUEL INJECTOR

(71) Applicant: CUMMINS INC., Columbus, IN (US)

(72) Inventors: John D. Lane, Columbus, IN (US); Brian Wright, Greenwood, IN (US); Daniel Fahlen, Stalhamravagen (SE); Sara Alfredsson, Hagersten (SE); Mats Eskner, Stockholm (SE); Steven E. Ferdon, Columbus, IN (US)

(21) Appl. No.: 14/819,561

(22) Filed: Aug. 6, 2015

Related U.S. Application Data
(63) Continuation-in-part of application No. 14/725,787, filed on May 29, 2015.

(51) Int. Cl. F02M 61/18; B22F 9/02; C22C 38/02; C22C 38/24; C22C 38/22; C22C 38/04; F02M 61/16; B22F 1/00

(52) U.S. Cl. CPC F02M 61/1886; F02M 61/168; F02M 61/166; B22F 9/026; B22F 1/0011; C22C 38/24; C22C 38/22; C22C 38/04; C22C 38/02

(57) ABSTRACT

A fuel injector includes an injector body having an injector cavity, a valve seat, and a flow control member. The valve seat is comprised of a metallic material having a grain size of 0.05-5.0 μm. Additionally, the fuel injector includes a nozzle valve element positioned in the injector cavity and configured to move between an open position in response to the flow control member being spaced apart from the valve seat and a closed position in response to the flow control member engaging the valve seat. Fuel is configured to flow from the fuel injector in response to the nozzle valve element being in the open position.

### CROSS-REFERENCE TO RELATED APPLICATIONS

The present application is a continuation-in-part of U.S. patent application Ser. No. 14/725,787, filed on May 29, 2015, and entitled “FUEL INJECTOR”, the complete disclosure of which is expressly incorporated by reference herein.

### TECHNICAL FIELD OF THE DISCLOSURE

The present disclosure relates to a fuel injector of an internal combustion engine and, more particularly, to a pilot valve seat of the fuel injector comprised of a compacted powder metal material.

### BACKGROUND OF THE DISCLOSURE

Fuel injectors include a pilot or control valve seat and a check valve ball for controlling fuel flow through the fuel injector. During operation of the fuel injector, the check ball moves from a closed position, in which the check valve ball is seated against the valve seat to inhibit fuel flow, to an open position, in which the check valve ball moves away from the valve seat to allow fuel flow. More particularly, the check valve ball is seated against the valve seat and fully in the closed position when the check valve ball is aligned along a longitudinal centerline of the valve seat.

Fuel injectors may be fluidly coupled to a high-pressure common rail such that the fuel flowing through the fuel injector is under high pressure and at a high velocity. Additionally, the length of a fuel cycle in a particular fuel injector may be approximately 1-3 microseconds. Due to the high pressure and high velocity of the fuel and the short duration of the fuel cycle, the check valve ball may move rapidly between the open and closed positions. When the check valve ball is in the open position, the ball may be moved off the longitudinal centerline of the valve seat by the fuel flow. On closing, the check valve ball may contact a conical wall of the valve seat at an off-center location away from the longitudinal centerline and may “slide” down the conical wall toward the seated position directly on the valve seat. This sliding action by the ball, the high pressure of the fuel, the high velocity of the fuel, and/or the large force exerted on the valve seat when the check valve ball returns to the closed position may lead to spalling at the valve seat. Spalling develops from cracks that occur in the sub-surface of the material comprising the valve seat which may eventually contribute to material flaking and decreased material strength at the valve seat.

### SUMMARY OF THE DISCLOSURE

In one embodiment of the present disclosure, a fuel injector comprises an injector body having an injector cavity, a valve seat, and a flow control member. The valve seat is comprised of a metallic material having a grain size of 0.05-5.0 μm. Additionally, the fuel injector comprises a nozzle valve element positioned in the injector cavity and configured to move between an open position in response to the flow control member being spaced apart from the valve seat and a closed position in response to the flow control member engaging the valve seat. Fuel is configured to flow from the fuel injector in response to the nozzle valve element being in the open position.

In another embodiment of the present disclosure, a method of manufacturing a valve seat of a fuel injector comprises providing a metallic material having a melting temperature, heating the metallic material to a liquid phase above the melting temperature, atomizing the metallic material when in the liquid phase, and forming powdered metallic particles having a diameter of less than 5.0 μm from the atomized metallic material. Additionally, the method comprises joining the powdered metallic particles to define a metallic mass and forming the valve seat from the metallic mass.

In a further embodiment of the present disclosure, a method of manufacturing a valve seat of a fuel injector comprises providing a metallic material, forming a plurality of powered particles from the metallic material, and joining the powdered particles to define a metallic mass. The metallic mass is a tool steel material having a grain size of less than 10.0 μm and comprising 1.0-2.0 wt. % carbon, 0.1-1.0 wt. % silicon, 0.1-1.0 wt. % manganese, 4.5-5.0 wt. % chromium, 3.0-4.0 wt. % molybdenum, and 3.5-4.5 wt. % vanadium. Additionally, the method comprises forming the valve seat from the metallic mass.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a cross-sectional view of a portion of a fuel injector of the present disclosure;

FIG. 2 is a detailed cross-sectional view of a pilot valve seat and flow control member of FIG. 1 and schematically showing a plurality of grains divided by grain boundaries throughout the pilot valve seat; and

FIG. 3 is an exploded view of the pilot valve seat and flow control member of FIG. 2.

### DETAILED DESCRIPTION OF THE DRAWINGS

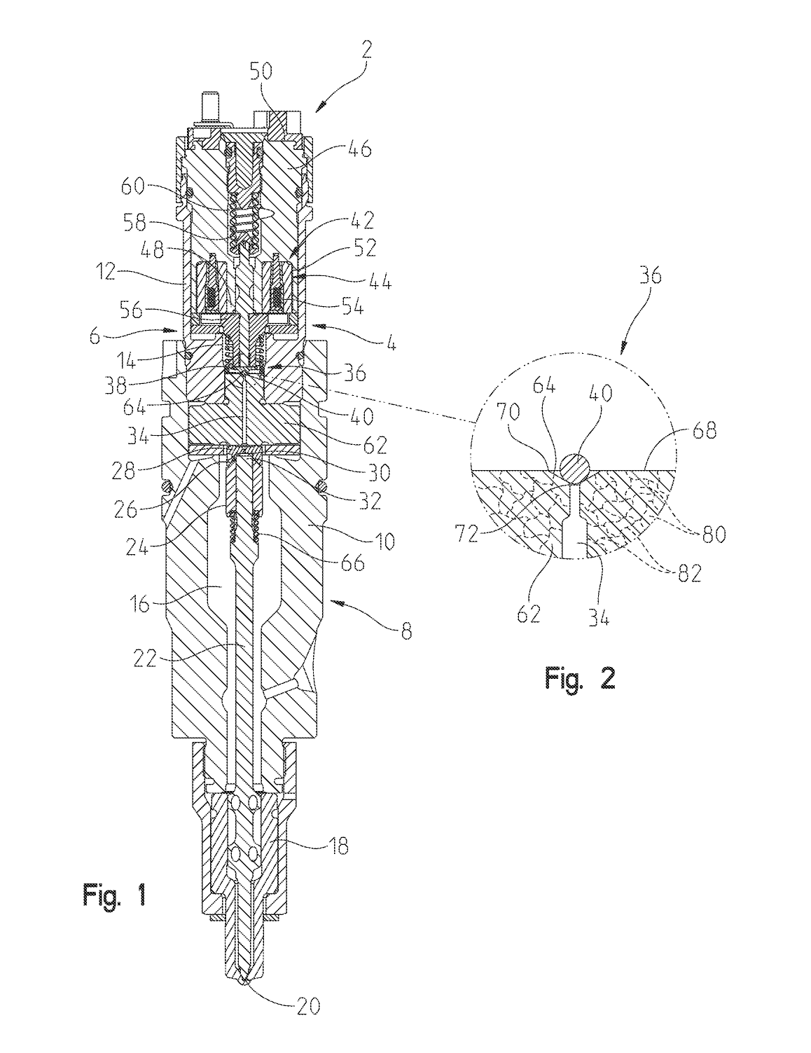

Referring to FIG. 1, a fuel system for an internal combustion engine (not shown) includes one or more fuel injectors 2. The fuel system may also include a fuel pump, a fuel accumulator, valves, and other elements (not shown) which are fluidly coupled to fuel injector 2. Fuel injector 2 is configured to inject metered quantities of fuel into a combustion chamber of the internal combustion engine in timed relation to the reciprocation of an engine piston (not shown).

As shown in FIG. 1, fuel injector 2 includes an injector body 4 which includes an injection control valve assembly 6, a nozzle module 8, an outer housing 10, and a valve housing 12. Valve housing 12 includes a valve cavity 14 for receiving injection control valve assembly 6 which is actuated by receiving a control signal from a controller (not shown) to cause nozzle module 8 to permit fuel flow into the combustion chamber of the internal combustion engine (not shown). Outer housing 10 secures injection control valve assembly 6, nozzle module 8, and other elements of fuel injector 2 in a fixed relationship. The structural and functional details of fuel injector 2 may be similar to those disclosed in U.S. Pat. Nos. 5,676,114 and 7,156,368, the complete disclosures of which are expressly incorporated by reference herein.

Referring to FIG. 1, nozzle module 8 includes a nozzle housing 18 positioned in outer housing 10 and an injector cavity 16 located within nozzle housing 18. Nozzle housing 18 further includes one or more injector orifices 20 positioned at a distal end of nozzle housing 18. Injector orifice(s) 20 communicate with one end of injector cavity 16 to discharge fuel into the combustion chamber of the engine (not shown). Nozzle module 8 further includes a nozzle or nozzle valve element 22 positioned in one end of injector cavity 16 adjacent to injector orifice(s) 20. Nozzle valve element 22 is movable between an open position which also denotes the beginning of an injection event because fuel may flow through injector orifice(s) 20 into the combustion chamber (not shown) and a closed position which denotes the end of the injection event because fuel flow through injector orifice(s) 20 is blocked or inhibited.

Nozzle module 8 includes a nozzle element guide 24 which includes a proximal cap or end portion 26 and a control volume plug 28. A control volume 30 is formed between an end portion 32 of nozzle valve element 22 and an interior of nozzle element guide 24 when nozzle valve element 22, nozzle element guide 24, and end portion 26 are mounted in injector cavity 16.

The pressure of fuel in control volume 30 determines whether nozzle valve element 22 is in an open position or a closed position, which is further determined by injection control valve assembly 6, as is further disclosed herein. When nozzle valve element 22 is positioned in injector cavity 16, nozzle element guide 24, and more specifically, end portion 26 of nozzle element guide 24, is positioned longitudinally between nozzle valve element 22 and injection control valve assembly 6.

Referring still to FIG. 1, at least one longitudinally-extending fuel delivery passage 34 extends through injection control valve assembly 6 to provide high-pressure fuel to injector cavity 16 and control volume 30. Injection control valve assembly 6 includes valve housing 12, valve cavity 14, and an injection control valve 36 positioned within valve cavity 14. Injection control valve 36 includes a control valve member 38, a flow control member, illustratively a check valve ball 40, a valve seat body 62 which includes a valve seat 64, and an actuator 42 to cause movement of check valve ball 40 between the open and closed positions relative to valve seat 64.

Control valve member 38 is positioned in valve cavity 14 and moves reciprocally between an open position, permitting check valve ball 40 to move longitudinally to permit fuel flow through fuel delivery passage 34, and a closed position, where check valve ball 40 blocks fuel flow through fuel delivery passage 34. Actuator 42 includes a solenoid assembly 44 that includes a stator housing 46 having a first end 48 and a second end 50, a stator core 52, an annular coil assembly 54 positioned circumferentially in and around stator core 52, and an armature 56 operably connected to control valve member 38. Stator housing 46 includes a central aperture or core 58 extending through stator housing 46 from first end 48 to second end 50. Central aperture 58 includes a spring cavity 60 and is positioned to receive control valve member 38. Stator core 52 is positioned on stator housing 46, and in the exemplary embodiment, stator core 52 is secured to stator housing 46.

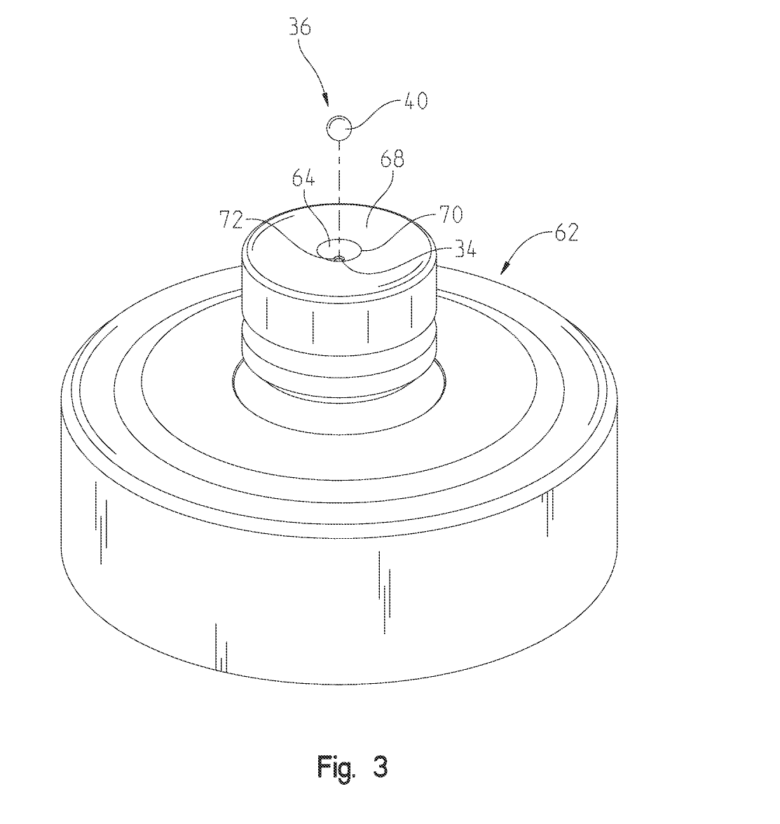

Referring to FIGS. 2 and 3, valve seat body 62 of injection control valve assembly 6 includes valve seat 64 and a seat body surface 68. Valve seat 64 is angled within valve seat body 62 such that a first end 70 of valve seat 64 intersects seat body surface 68 and a second end 72 of valve seat 64 intersects fuel delivery passage 34. When control valve member 38 is in the closed position, check valve ball 40 rests against valve seat 64 in a closed position, blocking fuel flow through fuel delivery passage 34. When control valve member 38 is in the open position, check valve ball 40 moves longitudinally away from valve seat 64 into an open position, permitting fuel to flow through fuel delivery passage 34.

As shown in FIGS. 1-3, when injection control valve assembly 6 is energized by the engine control system (not shown), solenoid assembly 44 is operable to move armature 56 longitudinally toward stator core 52. Movement of armature 56 causes control valve member 38 to move longitudinally away from valve seat 64, which permits control valve member 38 to move from valve seat 64, which causes fuel to flow through fuel delivery passage 34. Fuel then flows between check valve ball 40 and valve seat 64 into valve cavity 14 toward a drain (not shown) to vent pressure in control volume 30. When the pressure in control volume 30 is vented, the pressure imbalance created by the venting pressure causes nozzle valve element 22 to life to the open position, thereby uncovering injector orifices 20. Fuel is then directed toward injector orifices 20 and into the combustion chamber of the engine (not shown).

Referring again to FIGS. 1-3, injection control valve 36 is configured to control a beginning and an end of a fuel injection event. More particularly, injection control valve 36 may have variations in opening and closing which may lead to variations in the quantity of fuel delivered. In addition, each time injection control valve 36 opens or closes, the impact of check valve ball 40 opening or closing against valve seat 64 may lead to accumulating damage that permanently changes valve seat 64. Additionally, the surface of valve seat 64 may be affected by the high pressure and high velocity of the fuel flowing through injection control valve 36. The force of check valve ball 40 against valve seat 64, the high velocity of the fuel, and/or the high pressure of the fuel may affect the surface or geometry of valve seat 64 which may cause changes in the performance of fuel injector 2. For example, spalling may occur in valve seat 64 due to the force of check valve ball 40 against valve seat 64, the high velocity of the fuel, and/or the high pressure of the fuel. Spalling occurs when cracks form in the sub-surface of the material of valve seat 64, thereby decreasing strength and leading to potential flaking of the material comprising valve seat 64. Because valve seat 64 is comprised of a metallic alloy material, cracks may propagate from areas of the material of valve seat 64 with accumulations of various alloying elements (e.g., carbides). The metallic material comprising valve seat body 62 and valve seat 64 comprises a plurality of grains 80 defined by grain boundaries 82 extending between adjacent grains 80 (shown schematically in FIG. 2). In one embodiment, accumulations of alloying elements, such as carbide matrices, may form at grain boundaries 82 of the material comprising valve seat 64 and cracks may propagate from grain boundaries 82 and through grains 80 of the material in the sub-surface of valve seat 64.

To reduce spalling, exemplary valve seat body 62 is fabricated from a metallic material and, more particularly, from a tool steel formed by a powdered metallurgy process. In one embodiment, the powdered metal tool steel (“PMTS”) of valve seat body 62 is a fine-grain material generally comprising grains 80 with a grain size of less than 10 μm. For example, grains 80 of the PMTS comprising valve seat body 62 and, therefore valve seat 64, may have a grain size of 0.05-8.0 μm and, more particularly, 0.05-4.0 μm. By decreasing the grain size of the PMTS comprising valve seat body 62, the toughness, and, therefore, the fatigue strength, of the PMTS of valve seat body 62 is increased relative to other metallic materials with larger grain sizes, such as grains sizes of more than 10 μm.

Prior to a hardening process, grains 80 of the PMTS comprise a tool steel material having a face-centered cubic crystalline microstructure. However, grains 80 forming the PMTS of valve seat body 62 and, therefore valve seat 64, comprise a martensitic steel material having a body-centered tetragonal crystalline microstructure after undergoing a hardening process. For example, the PMTS comprising valve seat body 62 and valve seat 64 is a tool steel with 1.0-2.0 wt. % carbon, 0.1-1.0 wt. % silicon, 0.1-1.0 wt. % manganese, 4.5-5.0 wt. % chromium, 3.0-4.0 wt. % molybdenum, and 3.5-4.5 wt. % vanadium. More particularly, in one embodiment, the PMTS of valve seat body 62 and valve seat 64 comprises 1.4 wt. % carbon, 0.4 wt. % silicon, 0.4 wt. % manganese, 4.7 wt. % chromium, 3.5 wt. % molybdenum, and 3.7 wt. % vanadium.

To form the PMTS of valve seat body 62 and valve seat 64, metallic materials are melted into the molten phase and the molten material is sprayed with a compressed gas to atomize the metallic material and form small-diameter metallic particles. For example, the particles may have a diameter of 5-10 μm when sprayed to form the powdered metal. The spraying process instantly cools the molten metal particles which allows for uniform distribution of the alloying elements within each of the particles. As such, the grain size of the metallic material comprising the particles remains small, for example 0.05-10.0 μm and, more particularly, 0.05-4.0 μm. In one embodiment, the grain size of the PMTS of the present disclosure is approximately 0.16 μm. Additionally, because the alloying elements are uniformly distributed within each particle, the alloying elements do not accumulate at grain boundaries 82 of the metallic material. For example, carbide matrices do not accumulate at grain boundaries 82 and, therefore, stress concentrations resulting from accumulated carbide matrices are not introduced into the metallic material. In this way, the material at grain boundaries 82 comprises the same PMTS material as grains 80 forming valve seat body 62 and valve seat 64.

After the metallic material is atomized, the particles coalesce or are joined together to form PMTS metallic bars or slugs through a solid-state welding process. Solid-state welding processes join the individual particles together to form a solid mass at temperatures below the melting temperature of the metallic material. For example, in one embodiment, the powdered metal particles may be positioned within a mold or canister and are roll welded to form the metallic slugs. Additionally, in other embodiments, the powered metal particles may be formed into the PMTS slugs through any other solid-state welding process, such as powder forging, isostatic pressing, metal injection molding, cold welding, diffusion welding, and/or friction welding.

Once formed into the metallic slugs, further processes steps may occur, such as annealing, hardening, quenching, and/or tempering. Additionally, the PMTS slugs are then machined to form valve seat body 62 and valve seat 64 of fuel injector 2.

The material comprising valve seat body 62 and valve seat 64, when formed as disclosed herein, results in a PMTS with a grain size of approximately 0.05-10.0 μm, and more particularly 0.05-4.0 μm, a hardness of 55-70 Rockwell C, and more particularly 60 Rockwell C, a density of approximately 7,500-8,000 kg/m³, and more particularly 7,700 kg/m³, at 20° C., and a modulus of elasticity of 200,000-210,000 N/mm², and more particularly 206,000 N/mm², at 20° C. In one embodiment, the PMTS comprising valve seat body 62 and valve seat 64 may be Vanadis 4 Extra Super Clean available from Uddeholm.

The aforementioned properties of the PMTS comprising valve seat body 62 and valve seat 64 increase the fatigue strength of valve seat 64. The fatigue strength of valve seat 64 is increased because the small grain size and uniform distribution of the alloying elements comprising the PMTS decreases the accumulation of alloying elements at grain boundaries 82. Accumulations of alloying elements at grain boundaries 82 may occur through nitriding and/or carborizing processes and can trigger the initiation of sub-surface cracks which causes spalling. However, because the formation of the PMTS of the present disclosure does not utilize a nitriding or carborizing process and, instead, uniformly distributes the alloying elements throughout the material, the number of sub-surface crack initiation sites is reduced and the fatigue strength of the PMTS is increased. In this way, the PMTS is resistant to contact fatigue from the force of check valve ball 40 closing against valve seat 64 and the force of the high-pressure and high-velocity fuel flowing through valve seat 64. More particularly, the increased fatigue strength of the PMTS comprising valve seat body 62 and valve seat 64 increases the resistance to cracks that may occur within and propagate through grains 80 within the sub-surface of valve seat body 62 and valve seat 64 due to increased plastic strain within valve seat body 62. Therefore, spalling is reduced when valve seat body 62 and valve seat 64 is comprised of the PMTS of the present disclosure.

Additionally, the increased hardness of the PMTS comprising valve seat 64 decreases the need for a coating applied to valve seat 64. Therefore, the outermost surface of check valve ball 40 is configured to directly contact the outermost surface of valve seat 64 when in the closed in positioned because no coating is added to the outermost surface of valve seat 64 and, as such, no coating is positioned intermediate the outermost surfaces of valve seat 64 and check valve ball 40. Alternatively, in other embodiments, a coating may be applied to the outermost surface of valve seat 64 and/or check valve ball 40 to increase resistance to contact fatigue at valve seat 64.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A fuel injector, comprising:
an injector body having an injector cavity, a valve seat, and a flow control member, the valve seat being comprised of a metallic material having a grain size of 0.05-5.0 μm; and
a nozzle valve element positioned in the injector cavity and configured to move between an open position in response to the flow control member being spaced apart from the valve seat and a closed position in response to the flow control member engaging the valve seat, and fuel is configured to flow from the fuel injector in response to the nozzle valve element being in the open position.

2. The fuel injector of claim 1, wherein the grain size of the metallic material is less than one μm.

3. The fuel injector of claim 1, wherein the metallic material has a density of 7,500-8,000 kg/m³ at 15-25° C.

4. The fuel injector of claim 3, wherein the density is 7,700 kg/m³ at 20° C.

5. The fuel injector of claim 1, wherein the metallic material has a hardness of 58-62 Rockwell C.

6. The fuel injector of claim 1, wherein an outer surface of the flow control member contacts an outer surface of the valve seat when the nozzle valve element is in the closed position.

7. The fuel injector claim 1, wherein a grain boundary between the grains of the metallic material is comprised of the metallic material.

8. A method of manufacturing a valve seat of a fuel injector, comprising:
providing a metallic material having a melting temperature;
heating the metallic material to a liquid phase above the melting temperature;
atomizing the metallic material when in the liquid phase;
forming powdered metallic particles having a diameter of less than 5.0 μm from the atomized metallic material;
joining the powdered metallic particles to define a metallic mass; and
forming the valve seat from the metallic mass.

9. The method of claim 8, wherein the diameter of the powdered metallic particles is 5-10 μm.

10. The method of claim 8, wherein joining the powdered metallic particles includes welding the powdered metallic particles at a temperature below the melting temperature.

11. The method of claim 8, wherein joining the powdered metallic particles includes solid-state welding.

12. The method of claim 8, wherein the metallic mass defines a body-centered tetragonal crystalline microstructure.

13. A method of manufacturing a valve seat of a fuel injector, comprising:
providing a metallic material;
forming a plurality of powered particles from the metallic material;
joining the powdered particles to define a metallic mass, the metallic mass being a tool steel material having a grain size of less than 10.0 μm and comprising 1.0-2.0 wt. % carbon, 0.1-1.0 wt. % silicon, 0.1-1.0 wt. % manganese, 4.5-5.0 wt. % chromium, 3.0-4.0 wt. % molybdenum, and 3.5-4.5 wt. % vanadium; and
forming the valve seat from the metallic mass.

14. The method of claim 13, wherein a diameter of each of the powdered particles is 5-10 μm.

15. The method of claim 13, wherein joining the powdered particles includes solid-state welding.

16. The method of claim 13, wherein the tool steel defines a body-centered tetragonal crystalline microstructure.

17. The method of claim 13, wherein a grain boundary between the grains of the metallic mass is comprised of the tool steel.

18. The fuel injector of claim 13, wherein the metallic mass has a density of 7,500-8,000 kg/m³ at 15-25° C.

19. The fuel injector of claim 18, wherein the density is 7,700 kg/m³ at 20° C.

20. The fuel injector of claim 13, wherein the metallic mass has a hardness of 58-62 Rockwell C.
